(19) United States
(12) Patent Application Publication
(10) Pub. No.: US 2026/0140484 A1
(43) Pub. Date: May 21, 2026

(54) CLASS NEIGHBORHOOD GRAPH GENERATION FOR LAMELLA MILLING

(71) Applicant: FEI Company, Hillsboro, OR (US)

(72) Inventors: Jamie Dee Gravell, Brno (CZ); Tomáš Onderlicka, Brno (CZ); Matej Dolník, Slatina (CZ); Zoltán Orémuš, Šlapanice (CZ); Jakub Strejcek, Brno (CZ)

(21) Appl. No.: 18/950,590

(22) Filed: Nov. 18, 2024

(51) Int. Cl. G05B 13/02; G06V 10/82

(52) U.S. Cl. CPC G05B 13/027; G06V 10/82

(57) ABSTRACT

Systems or techniques are provided for spectral analysis. In various embodiments, a system can comprise a memory that stores computer executable components and a processor that executes the computer executable components stored in the memory. The computer executable components can comprise a graph generation component that generates a class neighborhood graph for a lamella milling processes, wherein the graph generation component generates the class neighborhood graph by: classifying structures within a region of interest of a design schematic of a sample; and generating a directed graph of the region of interest, wherein the directed graph comprises nodes representing the classified structures and weighted directed edges between the nodes representing distances between the classified structures.

### BACKGROUND

Machine learning processes are increasingly being utilized to control lamella milling, alternatively referred to endpointing. However, the training and fine tuning of such processes are difficult due to the material costs associated with preparing traditional training data.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate generation of class neighborhood graphs for lamella milling are provided.

According to one or more embodiments, a system is provided. The system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise graph generation component that generates a class neighborhood graph for a lamella milling processes, wherein the graph generation component generates the class neighborhood graph by: classifying structures within a region of interest of a design schematic of a sample; and generating a directed graph of the region of interest, wherein the directed graph comprises nodes representing the classified structures and weighted directed edges between the nodes representing distances between the classified structures.

An advantage of the system, and/or of a corresponding computer-implemented method and/or computer program product can be improved accuracy in the class neighborhood graph, thus improving performance of a lamella processing using such a class neighborhood graph.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings.

FIG. 1 is a block diagram of an example scientific instrument module for performing class neighborhood graph generation in accordance with various embodiments described herein.

FIG. 2 is a flow diagram of an example, non-limiting, method of performing class neighborhood graph generation in accordance with various embodiments described herein.

FIGS. 3 and 4 illustrate block diagrams of example, non-limiting, scientific instruments that facilitate class neighborhood graph generation and lamella milling in accordance with one or more embodiments described herein.

FIG. 5 illustrates an example of a region of interest of a non-limiting design schematic of a sample in accordance with one or more embodiments described herein.

FIG. 6 illustrates an example of a class neighborhood graph, in accordance with one or more embodiments described herein.

FIG. 7 illustrates a flow diagram of an example, non-limiting, computer-implemented method that can facilitate lamella endpointing in accordance with one or more embodiments described herein.

FIG. 8 illustrates a flow diagram of an example, non-limiting computer-implemented method that can mill lamella from samples in accordance with one or more embodiments described herein.

FIG. 9 illustrates a non-limiting example of a dual beam system capable of performing lamella milling in accordance with one or more embodiments described herein.

FIG. 10 illustrates a block diagram of an example, non-limiting, operating environment in which one or more embodiments described herein can be facilitated.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In various instances, the milling of lamella from samples can be useful as part of sample analysis. Lamella, as used herein, can refer to thin, small layers or slices of a larger manufactured specimen, such as semiconductor devices or circuit boards. The milling of lamella, alternatively referred to as endpointing, can be useful as it allows for isolation of structures or substructures of interest, that can then be imaged and studied in further detail. For example, a lamella of a transistor of a larger device can be prepared to allow for focused imaging of the transistor and/or the constituent parts of the transistor, such as gates, source drains and fins.

In various embodiments, neural networks can be utilized to instruct various instruments to perform such an end pointing process. However, training such neural networks poses several challenges. For example, training the neural network using a series of training images requires the milling a lamella for each training image. As the milling of such lamella requires the destruction of samples, producing a large enough training set of images requires the destruction of a large number of samples, making such training cost prohibitive. Accordingly, some endpointing neural networks instead operate using neighbor maps (alternatively referred to as class neighborhood graphs), which are graphs describing the layout of a region of interest of the sample, which a lamella is to be prepared of. This allows for the neural network to weight the classification process based on the graph. However, these neighbor maps are manually created for each sample and/or lamella and utilize fixed weights which only identify nearest and next nearest neighbor relations between structures of the region of interest. This negatively impacts the performance of such neural networks, as while the maps describe which structures are nearest neighbors, they do not capture the distances between structures or the density of structures within the region of interest.

To overcome the one or more deficiencies of existing technologies as identified above, one or more embodiments described herein can generate a class neighborhood graph for a lamella milling process, wherein the generation of the class neighborhood graph comprises: classifying structures within a region of interest of a design schematic of a sample, and generating a directed graph of the region of interest, wherein the directed graph comprises nodes representing the classified structures and weighted directed edges between the nodes representing distances between the classified structures. By capturing the relative distances between structures as directed edges, wherein shorter distances are represented by higher weights, the class neighborhood graph better captures the relative positions and the density of the region of interest. For example, given a region of interest with five closely spaced structures, existing class neighborhood graph approaches would only capture nearest and next neighbor relationships, and not the fact that all five structures are closely spaced. In contrast, the approach described herein would comprise edges between all five structures, which describe the relative distances, thereby more accurately capturing the density of the region of interest.

One or more embodiments are now described with reference to the drawings, where like referenced numerals are used to refer to like elements throughout. In the following description, for purposes of explanation, numerous specific details are set forth to provide a more thorough understanding of the one or more embodiments. It is evident in various cases, however, that the one or more embodiments can be practiced without these specific details.

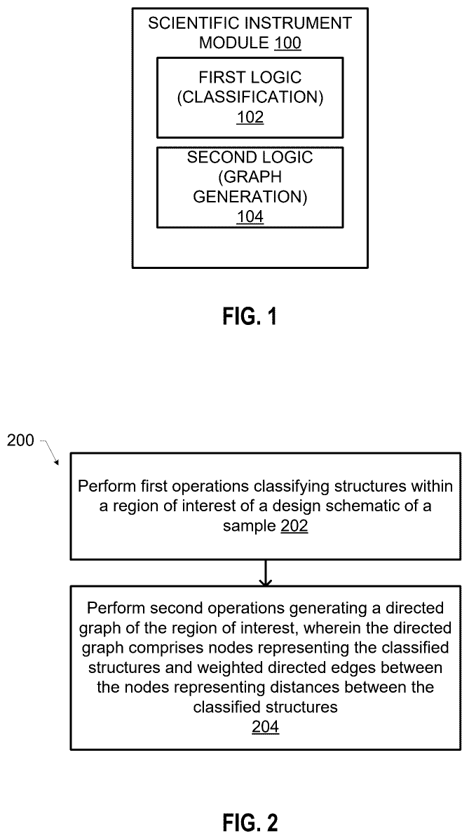

FIG. 1 illustrates an example, non-limiting block diagram of a scientific instrument module 100 in accordance with various embodiments described herein.

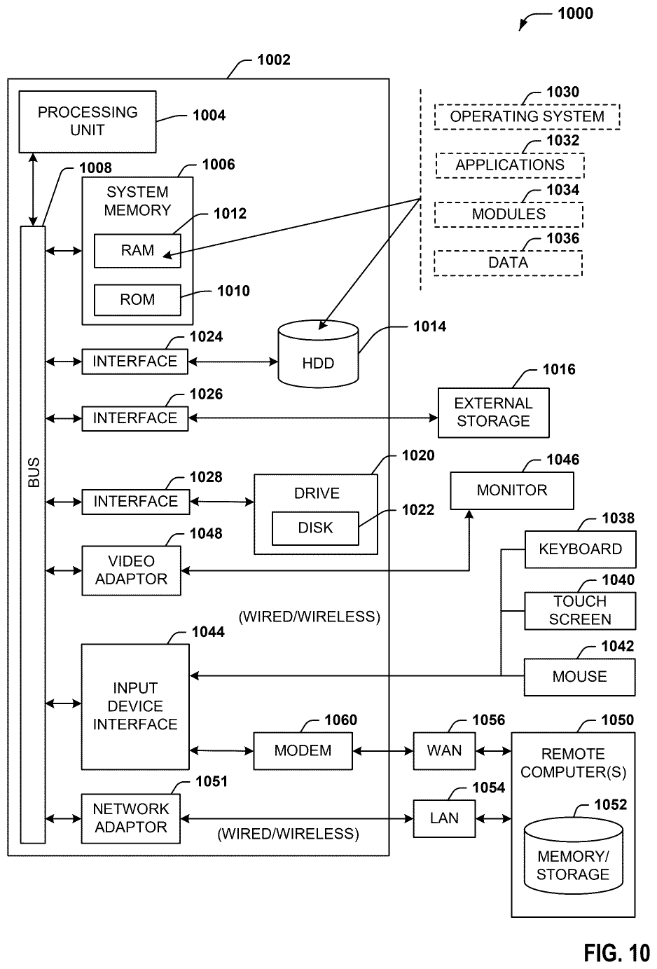

In various embodiments, the scientific instrument module 100 can be implemented by circuitry (e.g., including electrical or optical components), such as a programmed computing device. Logic of the scientific instrument module 100 can be included in a single computing device or can be distributed across multiple computing devices that are in communication with each other as appropriate. Examples of computing devices that may, singly or in combination, implement the scientific instrument module 100 are discussed herein with reference to FIG. 10.

The scientific instrument module 100 may include first logic 102 and second logic 104. As used herein, the term “logic” may include an apparatus that is to perform a set of operations associated with the logic elements. For example, any of the logic elements included in the scientific instrument module 100 may be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” may refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module may not include all of the logic elements depicted in the associated drawing; for example, a module may include a subset of the logic elements depicted in the associated drawing when that module is to perform a subset of the operations discussed herein with reference to that module.

In various embodiments, there can be a scientific instrument corresponding to the scientific instrument module 100. In various aspects, the scientific instrument can be any suitable computerized device that can electronically measure some scientifically-relevant, clinically-relevant, or research-relevant characteristic, property, or attribute of an analytical sample (e.g., of a known or unknown mixture, compound, or collection of matter). As a non-limiting example, a scientific instrument can be a scanning electron microscope. In such case, the scientific instrument can measure or determine a surface topography of the analytical specimen. As yet another non-limiting example, a scientific instrument can be a transmission electron microscope. In such case, the scientific instrument can measure or determine internal structural details of the analytical specimen. As a more general non-limiting example, a scientific instrument can be any suitable type of charged-particle microscope (e.g., some types of microscopes can use beams of non-electron ions to capture images).

In some situations, the scientific instrument can be able to perform both imaging and milling of a lamella that is cut or extracted from an analytical specimen. As a non-limiting example, the scientific instrument can be a dual beam microscope that is equipped with both an ion beam emitter and an electron beam emitter. In such case, the ion beam emitter can facilitate milling (e.g., material removal) of the lamella at various voltage, current, or power levels, and the electron beam emitter can (in conjunction with electron detectors and optical lenses) facilitate imaging of the lamella.

The first logic 102 may classify structures within a region of interest of a design schematic of a sample. For example, the structures can be classified by their purpose or material such as metal layer, gates, source drains and other classifications.

The second logic 104 may generate a directed graph of the region of interest, wherein the directed graph comprises nodes representing the classified structures and weighted directed edges between the nodes representing distances between the classified structures. For example, the weight of the edges can represent the distances between classified structures and the direction of the edges can represent the relative depths of the classified structures. Accordingly, a structure that is nearer to the surface of the sample will have directed edges towards the structures that are deeper within the sample.

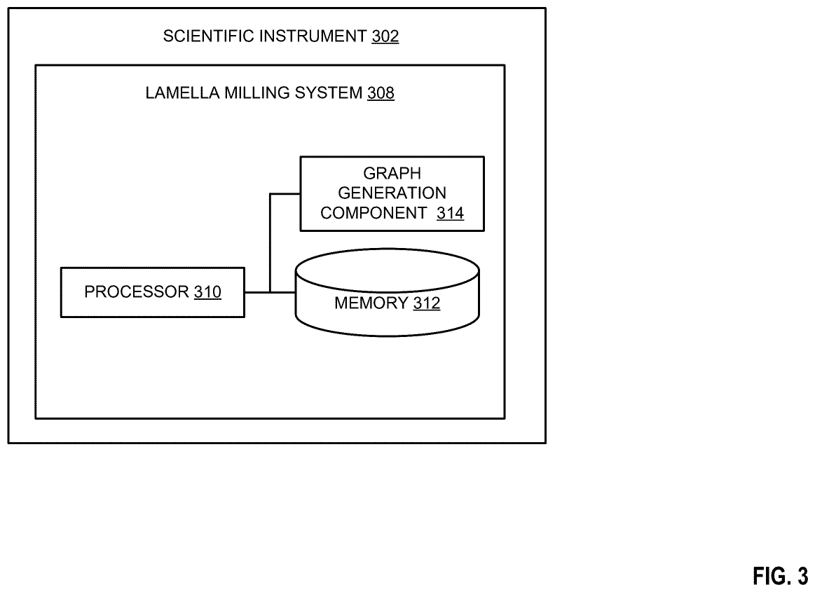

FIG. 2 is a flow diagram of a computer-implemented method 200 in accordance with one or more embodiments described herein. The operations of the computer-implemented method 200 may be used in any suitable setting to perform any suitable operations (e.g., can be performed by or used in conjunction with any of the various modules, computing devices, or graphical user interfaces described with respect to of FIGS. 1, 2, 11, 12 and 13). Operations are illustrated once each and in a particular order in FIG. 2, but the operations may be reordered or repeated as desired and appropriate (e.g., different operations performed may be performed in parallel, as suitable).

At 202, first operations may be performed. For example, the first logic 102 of scientific instrument module 100 may perform the operations of 202. The first operations may include classifying structures within the region of interest of the sample.

At 204, second operations may be performed. For example, the second logic 104 of scientific instrument module 100 may perform the operations of 204. The second operations may comprise generating the directed graph of the various classified structures.

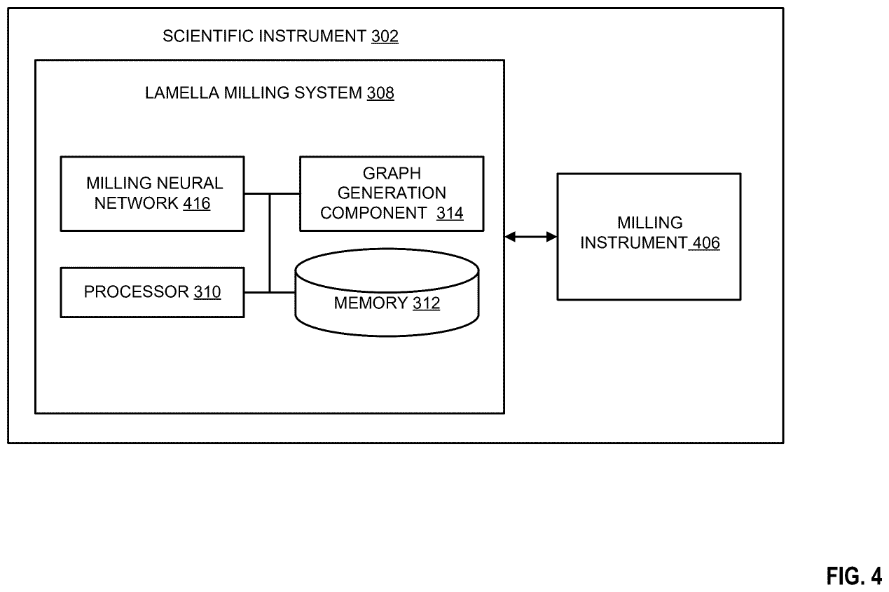

FIG. 3 illustrates a block diagram of an example, non-limiting scientific instrument that can facilitate clock synchronization in accordance with one or more embodiments described herein.

In various embodiments, the scientific instrument 302 can comprise a lamella milling system 308. In various cases the lamella milling system 308 can facilitate the milling or end pointing of lamella from samples.

In various aspects, the system 308 can comprise a processor 310 (e.g., computer processing unit, microprocessor) and a non-transitory computer-readable memory 312 that is operably or operatively or communicatively connected or coupled to the processor 310. The non-transitory computer-readable memory 312 can store computer-executable instructions which, upon execution by the processor 310, can cause the processor 310 or other components of system 308 (e.g., graph generation component 314) to perform one or more acts. In various embodiments, the non-transitory computer-readable memory 312 can store computer-executable components (e.g., graph generation component 314), and the processor 310 can execute the computer-executable components.

In various embodiments, graph generation component 314 can generate a class neighborhood graph for a lamella milling processes. For example, graph generation component 314 can receive a design schematic of a sample and region of interest for the lamella milling. The region of interest can be centered on a portion of the sample that is of interest for further analysis. Accordingly, the region of interest can comprise left and right boundaries for the lamella, a safety stop thickness and an intended final thickness. In one more embodiments, the safety stop thickness can serve as a boundary point where a more finely tuned milling process can be utilized to reach the final thickness. In this manner damage to the intended target of the sample can be avoided.

In various embodiments, graph generation component 314 can classify structures within the defined region of interest. For example, in some embodiments, the design schematic can comprise a textual description or design file (such as a CAD or GDS file) in which the structures are already labeled as belonging to one or more classes. These class labels can be based on the types of structures within the sample. For example, within a semiconductor device example classes can comprise, “gate” “metal layer” “source drain” or other portions of a semiconductor device. In the case that the design schematic the structure descriptions can then be extracted from the textual description for further use.

In an alternative embodiment, the design schematic can comprise an image or illustration of the sample. In this embodiment, graph generation component 314 can utilize an image processing subcomponent that identifies or classifies structures within the image. Alternatively, graph generation component 314 can further comprise a classification model than can perform image segmentation on the image or illustration of sample in order to identify and classify the structures within the image or illustration of the sample. For example, the classification model can be trained to classify the various components and subcomponents of semiconductor devices or circuit boards. The classification model can then classify all of the structures within the image or illustration as belonging to one of the learned classes.

In various embodiments, graph generation component 314 can further generate a directed graph of the region on interest, wherein the directed graph comprises node representing the classified structures and weighted directed edges between the nodes representing distances between the classified structures. For example, in the case the design schematic comprises a textual description or design file, graph generation component 314 can extract the positional coordinates and dimensions of each of the classified structures. Distances between the structures can then be determined based on a comparison of the relative positional coordinates. In the case that the design schematic comprises an image or illustration, graph generation component 314 can utilize image segmentation to identify center points of each of the classified shapes and distances can then be determined based on comparisons of the positional coordinates of the identified center points. Alternatively, graph generation component 314 can generate lines from the center point of a first classified shape to the center point of a second classified shape. Graph generation component 314 can then determine the distance between where the line crosses the boundary of the first classified shape and where the line crosses the boundary of the second classified shape. Once distances have been determined, graph generation component 314 can generate nodes for each of the classified structures that represent the assigned classes. Directed edges can then be added between nodes that lead from structures higher up within the sample to those deeper within. The edges can further be individually weighted based on the determined distances, such that smaller distances are weighted higher. For example, in one or more embodiments, the weight can be determined by subtracting the distance from an upper limit number, wherein a weight of the upper limit number represents a distance of zero.

FIG. 4 illustrates a block diagram of an example, non-limiting scientific instrument that can facilitate lamella milling in accordance with one or more embodiments described herein. As shown, scientific instrument 302 can comprise lamella milling system 308 as described above in relation to FIG. 3. Lamella milling system 308 of FIG. 4 can further comprise milling neural network 416 and milling instrument 406.

In various embodiments, milling instrument 406 can be able to perform both imaging and milling of a lamella that is cut or extracted from an analytical specimen. As a non-limiting example, the milling instrument 406 can be a dual beam microscope that is equipped with both an ion beam emitter and an electron beam emitter. In such case, the ion beam emitter can facilitate milling (e.g., material removal) of the lamella at various voltage, current, or power levels, and the electron beam emitter can (in conjunction with electron detectors and optical lenses) facilitate imaging of the lamella.

In various embodiments, milling neural network 416 can instruct milling instrument 406 as part of an endpointing process. For example, milling instrument 406 can capture an image of the region of interest of the sample. Milling neural network 416 can then classify one or more structures within the image. As part of this classification milling neural network 416 can first generate a raw classification label and then modify the raw classification label using the weights or probabilities from the class neighborhood graph. For example, given than a structure of class A was previously identified, when the next image of a cutface of the region of interest is captured, milling neural network 416 can use the weights of the edges leading from the node of class A to other nodes within the graph to weight the classification process in favor of structures that are physically closer to class A (e.g., higher weights) and below class A (e.g., directed edges leading from class A to other classes) relative to the direction of the milling. In this manner, the classification process performed by milling neural network 416 can be augmented and finetuned for specific samples without the need of extensive training data. If milling neural network 416 does not identify a target structure within the image, milling neural network 416 can instruct milling instrument 406 to continue milling the sample. If the target structure is identified, then milling neural network 416 can instruct milling instrument 406 to end the milling process.

According to some embodiments, milling neural network 416 can employ automated learning and reasoning procedures (e.g., the use of explicitly and/or implicitly trained statistical classifiers) in connection with performing inference and/or probabilistic determinations and/or statistical-based determinations in accordance with one or more aspects described herein.

For example, milling neural network 416 can employ principles of probabilistic and decision theoretic inference to determine classifications of structures in images and what milling instructions should be performed next as part of a lamella milling process. In various embodiments, milling neural network 416 can employ a knowledge source database comprising previously classified structure images. Additionally, or alternatively, milling neural network 416 can rely on predictive models constructed using machine learning and/or automated learning procedures. Logic-centric inference can also be employed separately or in conjunction with probabilistic methods. For example, decision tree learning can be utilized to map observations about data retained in a knowledge source database to derive an appropriate classification and/or milling instruction.

As used herein, the term “inference” refers generally to the process of reasoning about or inferring states of the system, a component, a module, the environment, and/or assessments from one or more observations captured through events, reports, data, and/or through other forms of communication. Inference can be employed to identify a specific context or action, or can generate a probability distribution over states, for example. The inference can be probabilistic. For example, computation of a probability distribution over states of interest can be based on a consideration of data and/or events. The inference can also refer to techniques employed for composing higher-level events from one or more events and/or data. Such inference can result in the construction of new events and/or actions from one or more observed events and/or stored event data, whether or not the events are correlated in close temporal proximity, and whether the events and/or data come from one or several events and/or data sources. Various classification schemes and/or systems (e.g., support vector machines, neural networks, logic-centric production systems, Bayesian belief networks, fuzzy logic, data fusion engines, and so on) can be employed in connection with performing automatic and/or inferred action in connection with the disclosed aspects. Furthermore, the inference processes can be based on stochastic or deterministic methods, such as random sampling, Monte Carlo Tree Search, and so on.

The various aspects can employ various artificial intelligence-based schemes for carrying out various aspects thereof. For example, a process of classifying exposed structures and determining next milling instructions, without interaction from the target entity, which can be enabled through an automatic classifier system and process.

A classifier is a function that maps an input attribute vector, x=(x1, x2, x3, x4, xn), to a confidence that the input belongs to a class. In other words, f(x)=confidence(class). Such classification can employ a probabilistic and/or statistical-based analysis (e.g., factoring into the analysis utilities and costs) to prognose or infer an action that should be employed to make a determination. The determination can include, but is not limited to, classification of exposed structures and next milling steps to execute.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that can be similar, but not necessarily identical to training data. Other directed and undirected model classification approaches (e.g., naïve Bayes, Bayesian networks, decision trees, neural networks, fuzzy logic models, and probabilistic classification models) providing different patterns of independence can be employed. Classification as used herein, can be inclusive of statistical regression that is utilized to develop models of priority.

One or more aspects can employ classifiers that are explicitly trained (e.g., through a generic training data) as well as classifiers that are implicitly trained (e.g., by observing and recording target entity behavior, by receiving extrinsic information, and so on). For example, SVM's can be configured through a learning phase or a training phase within a classifier constructor and feature selection module. Thus, a classifier(s) can be used to automatically learn and perform a number of functions, including but not limited to selection of match fragmentation patterns from one or more possible match fragmentation patterns. Furthermore, one or more aspects can employ machine learning models that are trained utilizing reinforcement learning. For example, penalty/reward scores can be assigned for various outputs generated by milling neural network 416 based on defined entity preferences. Accordingly, milling neural network 416 can learn via selecting options with lower penalties and/or higher rewards in order to reduce an overall penalty score and/or increase an overall reward score.

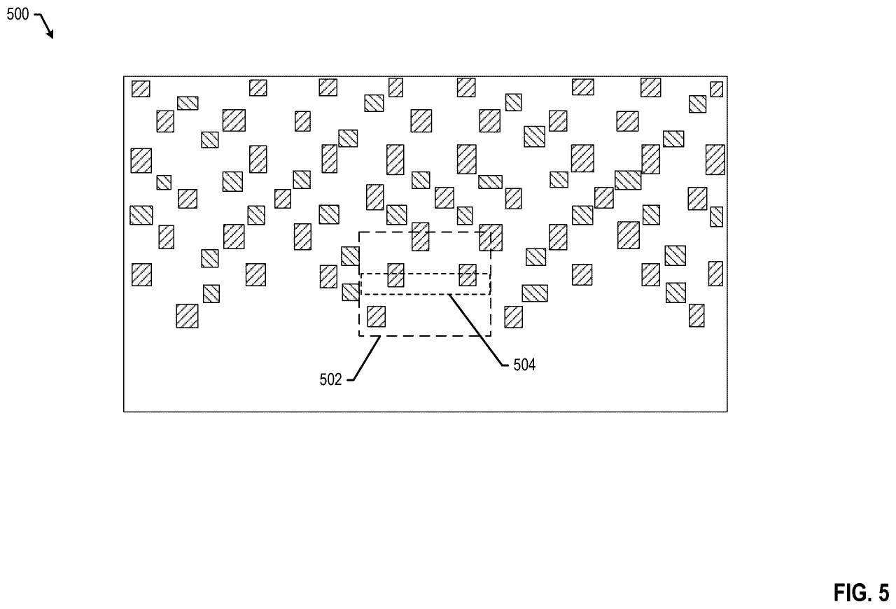

FIG. 5 illustrates an example of a region of interest of a non-limiting design schematic of a sample in accordance with one or more embodiments described herein.

As shown, design schematic 500 comprises a multitude of structures, in this example comprising two different types. As shown, the region of interest 502 can further comprise a final thickness region 504. In one or more embodiments, a first milling process, such as a 30 kV ion beam can be utilized to reach the boundaries of the region of interest. In order to prevent damage to the intended target of the end pointing, a fine-tuned milling process, such as a 10 kV ion beam, can be utilized to further mill down to the final thickness region 504.

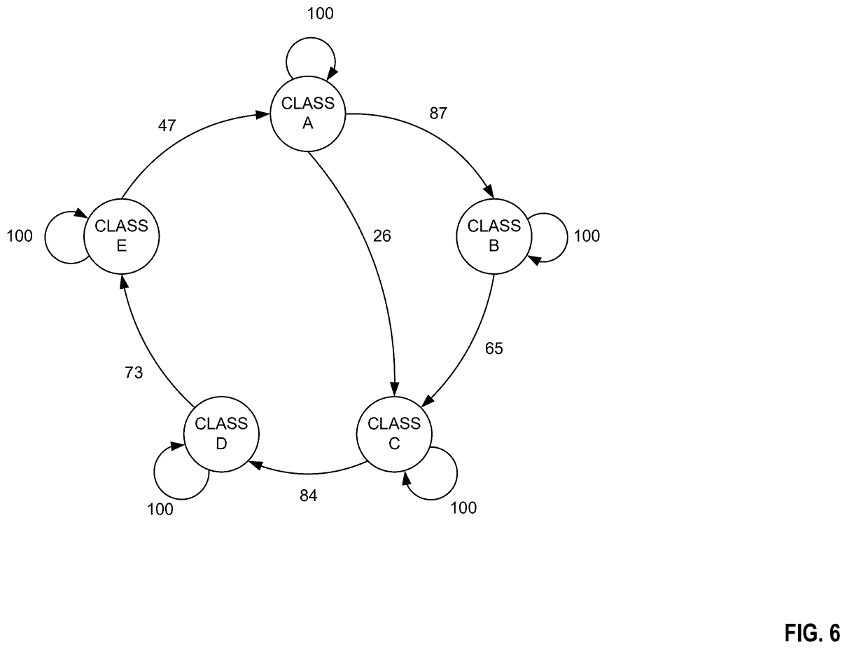

FIG. 6 illustrates an example of a class neighborhood graph 600, in accordance with one or more embodiments described herein.

As shown, class neighborhood graph 600 comprises five classes, class A representing a structure A, class B representing a structure B, class C representing a structure C, class D representing a structure D, and class E representing a structure E. In various embodiments, the weights can be determined by subtracting the distance between structures from 100. Accordingly, smaller distances produce a higher weight value. As shown, there are various directed weighted edges connecting the various nodes. As shown, class A has a directed edge with a weight of 100 pointing back to class A. Class A further has a directed edge weighted 87 pointing to class B. This signifies that class A and class B are located relatively close to one another, with class B being located below class A relative to the direction of the milling. Class A further has a directed edge weighted 26 pointing to class C. This signifies that class C is located relatively far away and below class A relative to the direction of the milling.

As shown, class B has a directed edge with a weight of 100 pointing back to class B. Class B further has a directed edge with a weight of 65 pointing to class C. This signifies that class C is relatively close to class B and below class B relative to the direction of the milling.

As shown, class C has a directed edge with a weight of 100 pointing back to class C. Class C further has a directed edge with a weight of 84 pointing to class C. This signifies that class D is close to class D and below class C relative to the direction of the milling.

As shown, class D has a directed edge with a weight of 100 pointing back to class D. Class D further has a directed edge with a weight of 73 pointing to class E. This signifies that class E is close to class D and below class D relative to the direction of the milling.

As shown, class E has a directed edge with a weight of 100 pointing back to class E. Class E further has a directed edge with a weight of 47 pointing to class A. This signifies that class A is moderately far from class E and below class E relative to the direction of milling.

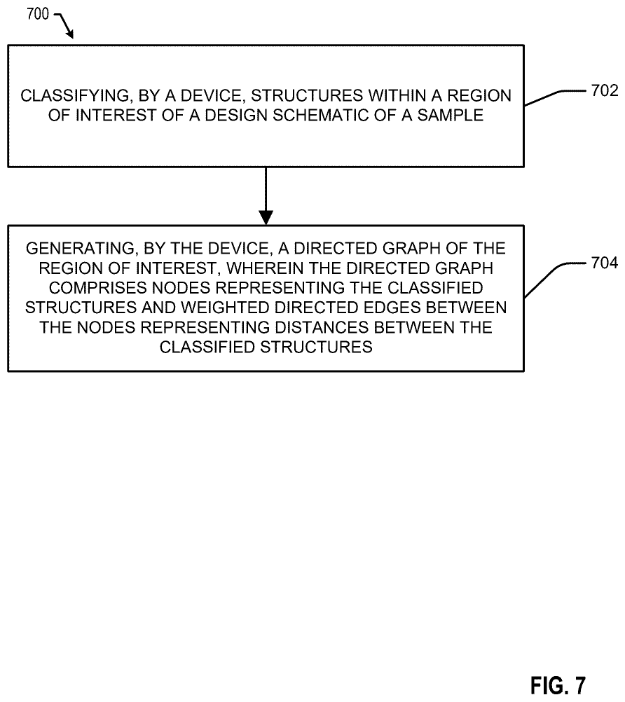

FIG. 7 illustrates a flow diagram of an example, non-limiting, computer-implemented method 700 that can facilitate lamella endpointing in accordance with one or more embodiments described herein.

In various cases, lamella milling system 308 can facilitate the computer-implemented method 700. In various embodiments, act 702 can comprise classifying, by a device (e.g., graph generation component 314), structures of a region of interest of a design schematic of a sample. For example, as described above in reference to FIGS. 3-4, graph generation component 314 can receive a design schematic of a sample for lamella milling. In the event that the design schematic comprises a textual description of the sample, graph generation component 314 can extract class descriptions of the structures from the design schematic. In the event that the design schematic comprises an illustration, image or diagram of the sample, graph generation component 314 can utilize a classification or image segmentation model to identify and classify structures within the design schematic.

In various embodiments, act 704 can comprise generating, by the device (e.g., graph generation component 316), a directed graph of the region of interest. For example, as described above in relation to FIGS. 3 and 4, graph generation component 316 can determine the distances between the various identified and classified structures. A node for each classified structure can then be created with weighted edges connecting the various nodes. The weights of the nodes can be representative of the distances between the classified structures, wherein smaller distances are given higher weights. Furthermore, the edges can be directed from structures with higher relative depths within the sample to those with lower relative depths. This directed graph can then be used as a class neighborhood graph as part of an endpointing process, allowing predictions of which structures are likely to be exposed during the milling.

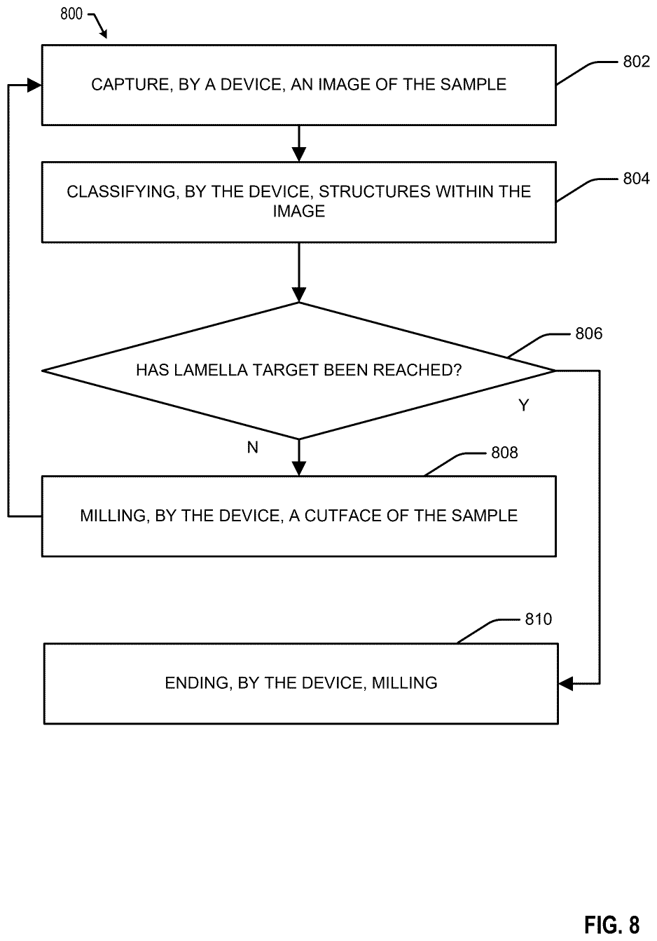

FIG. 8 illustrates a flow diagram of an example, non-limiting computer-implemented method 800 that can mill lamella from samples in accordance with one or more embodiments described herein.

In various cases, lamella milling system 308 can facilitate the computer-implemented method 800. In various embodiments, act 800 can comprise, capturing, by a device (e.g., milling instrument 406) an image of the sample. For example, in one or more embodiments, milling instrument 406 can comprise a dual beam microscope that can capture an image of the sample.

In various embodiments, act 804 can comprise, classifying, by the device (e.g., milling neural network 416) structures within the image. For example, milling neural network 416 can utilize image segmentation to identify and classify structures within the image to determine where in the sample the milling process currently is. As part of this classification, the class neighborhood graph can be utilized to weight the classification appropriately. For example, milling neural network 416 can generate raw classification labels that are then modified using the weights of class neighborhood graph. As the milling process is likely to reveal new structures that are below relative to the direction of the milling and near to previously exposed structures in the cutface, these structures are weighted higher using the class neighborhood graph. For example, returning to class neighborhood graph 600 of FIG. 6, given that structure A has been previously identified by milling neural network 416, it is likely that in the new image, structure A is still present, or structure B has been revealed, as structure B is the closest to structure A and is beneath class A along the direction of the milling. Accordingly, the weights of the edges of the graph can be utilized to weight the classification process executed by milling neural network 416.

In various embodiments, act 806 can comprise determining, by the device (e.g., milling neural network 416) if the lamella target has been reached. For example, milling neural network 416 can receive a target structure within the sample that is intended to be exposed or isolated in the lamella. If the target structure was classified at step 804 (a YES determination) method 800 can end. If the target structure was not identified at step 804 (a NO determination) method 800 can proceed to step 808 and incremental milling of the cutface of the sample can be performed by milling instrument 406. From act 808, method 800 can return to act 800 to capture a new image of the cutface of the sample.

An advantage of the systems, and/or of corresponding computer-implemented methods and/or computer program products described herein can be the ability train or fine tune a milling neural network without the extensive use of images of physical lamella. For example, by fine tuning the milling neural network using a class neighborhood graph specific to each sample, the milling neural network does not need extensive training data images that require the destruction of samples to generate. Furthermore, by including weights representative of distances within the class neighborhood graph, the accuracy of the milling neural network can be improved.

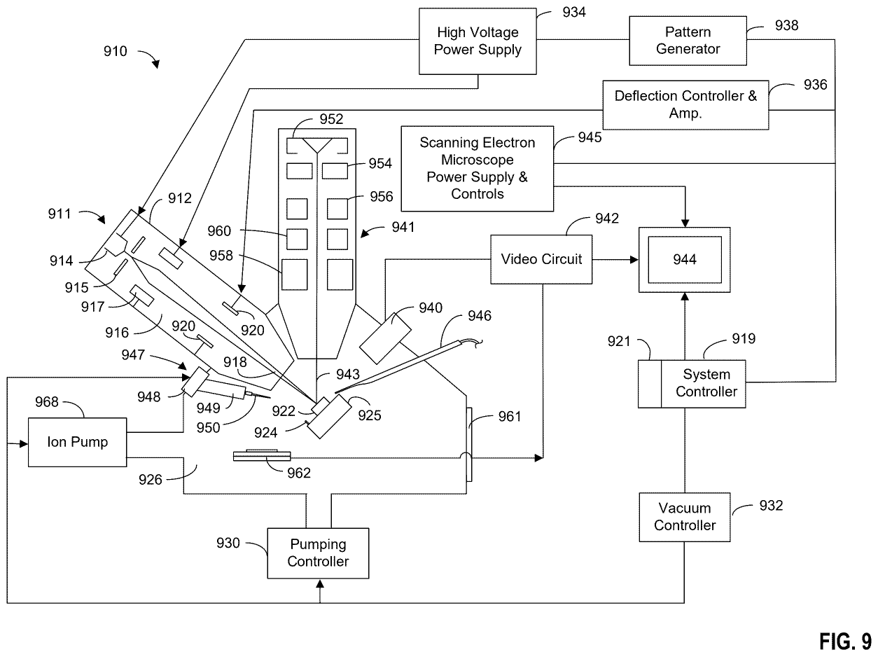

An example, non-limiting apparatus for performing various embodiments described herein is shown in FIG. 9. FIG. 9 illustrates a non-limiting example of a dual beam system 910 with a vertically mounted scanning electron microscope (SEM) column and a focused ion beam (FIB) column mounted at an angle of approximately 52 degrees from the vertical. In one or more embodiments, milling instrument 406 can comprise a dual beam system such as that described in FIG. 9. While FIG. 9 shows an example of suitable microscopy hardware with which various embodiments described herein can be implemented, it is to be appreciated that such microscopy hardware is non-limiting. In other words, various embodiments described herein can be implemented in conjunction with any other suitable types of microscopy hardware. The dual beam system 910 is a non-limiting example of the scientific instrument 302 or of any other scientific instruments discussed above.

A scanning electron microscope 941, along with a power supply and control unit 945, can be provided with the dual beam system 910. An electron beam 943 can be emitted from a cathode 952 by applying voltage between the cathode 952 and an anode 954. The electron beam 943 can be focused to a fine spot by means of a condensing lens 956 and an objective lens 958. The electron beam 943 can be scanned two-dimensionally on any suitable specimen by means of a deflection coil 960. Operation of the condensing lens 956, the objective lens 958, or the deflection coil 960 can be controlled by the power supply and control unit 945.

The electron beam 943 can be focused onto a substrate 922, which can be on a movable X-Y stage 925 within a lower chamber 926. When the electrons in the electron beam 943 strike the substrate 922, secondary electrons can be emitted. These secondary electrons can be detected by a secondary electron detector 940 as discussed below. A scanning transmission electron microscopy (STEM) detector 962, located beneath a transmission electron microscopy (TEM) sample holder 924 and the movable X-Y stage 925, can collect electrons that are transmitted through the sample mounted on the TEM sample holder 924 as discussed above.

The dual beam system 910 can also include a focused ion beam (FIB) system 911 which can comprise an evacuated chamber having an upper neck portion 912 within which can be located an ion source 914 and a focusing column 916 including extractor electrodes and an electrostatic optical system. The axis of the focusing column 916 can be tilted 52 degrees (or any other suitable angular displacement) from the axis of the electron column. The ion column 912 can include an ion source 914, an extraction electrode 915, a focusing element 917, deflection elements 920, and a focused ion beam 918. The focused ion beam 918 can pass from the ion source 914 through the focusing column 916 and between electrostatic deflection means schematically indicated at numeral 920 toward the substrate 922, which can comprise, for example, a semiconductor device positioned on the movable X-Y stage 925 within the lower chamber 926.

The movable X-Y stage 925 can move in a horizontal plane (along X and Y axes) and vertically (along Z axis). The movable X-Y stage 925 can tilt approximately sixty (60) degrees and rotate about the Z axis. In some embodiments, a separate TEM sample stage (not shown) can be used. Such a TEM sample stage can be moveable in the X, Y, and Z axes. A door 961 can be opened for inserting the substrate 922 onto the movable X-Y stage 925 or also for servicing an internal gas supply reservoir, if one is used. The door 961 can be interlocked so that it cannot be opened if the system is under vacuum.

An ion pump 968 can be employed for evacuating the neck portion 912. The chamber 926 can be evacuated with a turbomolecular and mechanical pumping system 930 under the control of a vacuum controller 932. Such vacuum system can provide within the chamber 926 a vacuum of between approximately 1×10⁻⁷ Torr and 5×10⁻⁴ Torr. If an etch assisting, an etch retarding gas, or a deposition precursor gas is used, the chamber background pressure may rise, typically to about 1×10⁻⁵ Torr.

A high voltage power supply 934 can provide an appropriate acceleration voltage to electrodes in the focusing column 916 for energizing and the focused ion beam 918. When it strikes the substrate 922, material can be sputtered (that is, physically ejected) from the sample. Alternatively, the focused ion beam 918 can decompose a precursor gas to deposit a material.

The high voltage power supply 934 can be connected to the ion source 914 (which can be a liquid metal ion source) as well as to appropriate electrodes in the ion beam focusing column 916 for forming an approximately 1 keV to 60 keV ion beam 918 and directing the same toward a sample. A deflection controller and amplifier 936, operated in accordance with a prescribed pattern provided by a pattern generator 938, can be coupled to the deflection elements 920 (which can be deflection plates) whereby the focused ion beam 918 may be controlled manually or automatically to trace out a corresponding pattern on the upper surface of the substrate 922. In some systems, the deflection elements 920 can be placed before the final lens. Beam blanking electrodes (not shown) within the ion beam focusing column 916 can cause the focused ion beam 918 to impact onto a blanking aperture (not shown) instead of the substrate 922 when a blanking controller (not shown) applies a blanking voltage to a blanking electrode.

The ion source 914 can provide a metal ion beam of gallium, for example. In other examples, the ion source 914 may be a plasma ion source that extracts ions from a generated plasma. The source can be capable of being focused into a sub one-tenth micrometer wide beam at the substrate 922 for either modifying the substrate 922 by ion milling, enhanced etch, material deposition, or for the purpose of imaging the substrate 922.

A charged particle detector 940, such as an Everhart Thornley or multi-channel plate, used for detecting secondary ion or electron emission can be connected to a video circuit 942 that can supply drive signals to a video monitor 944 and receive deflection signals from a system controller 919. The location of the charged particle detector 940 within the lower chamber 926 can vary in different embodiments. For example, the charged particle detector 940 can be coaxial with the ion beam and include a hole for allowing the ion beam to pass. In other embodiments, secondary particles can be collected through a final lens and then diverted off axis for collection.

A micromanipulator 947 can precisely move objects within the vacuum chamber. The micromanipulator 947 may comprise precision electric motors 948 positioned outside the vacuum chamber to provide X, Y, Z, and theta control of a portion 949 positioned within the vacuum chamber. The micromanipulator 947 can be fitted with different end effectors for manipulating small objects. In various embodiments described herein, the end effector can be a thin probe 950.

A gas delivery system 946 can extend into the lower chamber 926 for introducing and directing a gaseous vapor toward the substrate 922. For example, iodine can be delivered to enhance etching, or a metal organic compound can be delivered to deposit a metal.

The system controller 919 can control the operations of the various parts of the dual beam system 910. Through the system controller 919, a user can cause the focused ion beam 918 or the electron beam 943 to be scanned in a desired manner through commands entered into any suitable user interface (not shown). Alternatively, the system controller 919 may control the dual beam system 910 in accordance with programmed instructions stored in a memory 921. In various embodiments, any of the one or more software components 315 (e.g., graph generation component 314 and/or milling neural network 416) can be implemented in or otherwise executed by the system controller 919.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z1, z2, z3, z4, zn), to a confidence that the input belongs to a class, as by f(z)=confidence(class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

In order to provide additional context for various embodiments described herein, FIG. 13 and the following discussion are intended to provide a brief, general description of a suitable computing environment 1300 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and a drive 1020, e.g., such as a solid state drive, an optical disk drive, which can read or write from a disk 1022, such as a CD-ROM disc, a DVD, a BD, etc. Alternatively, where a solid state drive is involved, disk 1022 would not be included, unless separate. While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and drive 1020 can be connected to the system bus 1008 by an HDD interface 1024, an external storage interface 1026 and a drive interface 1028, respectively. The interface 1024 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the . NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1094 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above, such as but not limited to a network virtual machine providing one or more aspects of storage or processing of information. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Various non-limiting aspects are described in the following examples.

EXAMPLE 1: A system comprising: a memory that stores computer executable components; and a processor that executes the computer executable components stored in the memory, wherein the computer executable components comprise: a graph generation component that generates a class neighborhood graph for a lamella milling processes, wherein the graph generation component generates the class neighborhood graph by: classifying structures within a region of interest of a design schematic of a sample; and generating a directed graph of the region of interest, wherein the directed graph comprises nodes representing the classified structures and weighted directed edges between the nodes representing distances between the classified structures.

EXAMPLE 2: The system of any preceding example, wherein the design schematic comprises a diagram of the sample and the region of interest, and wherein the graph generation component further generates the class neighborhood graph by determining the distances between the classified structures based on measurements from center points of the classified structures to center points of other classified structures.

EXAMPLE 3: The system of any preceding example, wherein the graph generation component comprises an image processing subcomponent that classifies the structures within the region of interest.

EXAMPLE 4: The system of any preceding example, wherein the design schematic comprises a textual description of the sample, and wherein the graph generation component further generates the class neighborhood graph by determining the distances between the classified structures based on an extraction of the distances from the textual description.

EXAMPLE 5: The system of any preceding example, wherein the graph generation component classifies the structures based on an extraction of class descriptions within the textual description.

EXAMPLE 6: The system of any preceding example, wherein the region of interest comprises a left boundary, a right boundary, a first milling stage thickness and a final thickness.

EXAMPLE 7: The system of any preceding example, wherein the computer executable components further comprise, a milling neural network that classifies one or more structures in an image of a cutface of the sample, modifies the classifications based on the class neighborhood graph, and instructs a scientific instrument to mill the sample based on the modified classifications.

In various aspects, any combination or combinations of EXAMPLES 1-7 can be implemented.

EXAMPLE 8: A computer-implemented method comprising: generating, by a device operatively coupled to a processor, a class neighborhood graph for a lamella milling process, wherein the generating comprises: classifying, by the device, structures within a region of interest of a design schematic of a sample; and generating, by the device, a directed graph of the region of interest, wherein the directed graph comprises nodes representing the classified structures and weighted directed edges between the nodes representing distances between the classified structures.

EXAMPLE 9: The computer-implemented method of any preceding example, wherein the design schematic comprises a diagram of the sample and the region of interest and further comprising determining, by the device, the distances between the classified structures based on measurements from center points of the classified structures to center points of other classified structures.

EXAMPLE 10: The computer-implemented method of any preceding example, further comprising classifying, by the device, the structures within the region of interest.

EXAMPLE 11: The computer-implemented method of any preceding example, wherein the design schematic comprises a textual description of the sample and further comprising determining, by the device, the distances between the classified structures based on an extraction of the distances from the textual description.

EXAMPLE 12: The computer-implemented method of any preceding example, further comprising classifying, by the device, the structures based on an extraction of class descriptions within the textual description.

EXAMPLE 13: The computer-implemented method of any preceding example, wherein the region of interest comprises a left boundary, a right boundary, a first milling stage thickness and a final thickness.

EXAMPLE 14: The computer-implemented method of any preceding example, further comprising: classifying, by the device, using a milling neural network, one or more structures in an image of a cutface of the sample; modifying, by the device, the classifications based on the class neighborhood graph; and instructing, by the device, a scientific instrument to mill the sample based on the modified classifications.

In various aspects, any combination or combinations of EXAMPLES 8-14 can be implemented.

EXAMPLE 15: A computer program product comprising a non-transitory computer-readable memory having program instructions embodied therewith, the program instructions executable by a processor to cause the processor to: generate, by the processor, a class neighborhood graph for a lamella milling processes, wherein the generation causes the processor to: classify, by the processor, structures within a region of interest of a design schematic of a sample; and generate, by the processor, a directed graph of the region of interest, wherein the directed graph comprises nodes representing the classified structures and weighted directed edges between the nodes representing distances between the classified structures.

EXAMPLE 16: The computer program product of any preceding example, wherein the design schematic comprises a diagram of the sample and the region of interest, and wherein the program instructions are further executable by the processor to cause the processor to determine the distances between the classified structures based on measurements from center points of the classified structures to center points of other classified structures.

EXAMPLE 17: The computer program product of any preceding example, wherein the program instructions are further executable by the processor to cause the processor to classify the structures within the region of interest.

EXAMPLE 18: The computer program product of any preceding example, wherein the design schematic comprises a textual description of the sample, and wherein the program instructions are further executable by the processor to cause the processor to determine the distances between the classified structures based on an extraction of the distances from the textual description.

EXAMPLE 19: The computer program product of any preceding example, wherein the program instructions are further executable by the processor to cause the processor to classify the structures based on an extraction of class descriptions within the textual description.

EXAMPLE 20: The computer program product of any preceding example, wherein the program instructions are further executable by the processor to cause the processor to: classify, using a milling neural network, one or more structures in an image of a cutface of the sample; modify the classifications based on the class neighborhood graph; and instruct a scientific instrument to mill the sample based on the modified classifications.

In various aspects, any combination or combinations of EXAMPLES 15-20 can be implemented.

In various aspects, any combination or combinations of EXAMPLES 1-20 can be implemented.

What is claimed is:

1. A system comprising:
a memory that stores computer executable components; and
a processor that executes the computer executable components stored in the memory, wherein the computer executable components comprise:
graph generation component that generates a class neighborhood graph for a lamella milling processes, wherein the graph generation component generates the class neighborhood graph by:
classifying structures within a region of interest of a design schematic of a sample; and
generating a directed graph of the region of interest, wherein the directed graph comprises nodes representing the classified structures and weighted directed edges between the nodes representing distances between the classified structures.

2. The system of claim 1, wherein the design schematic comprises a diagram of the sample and the region of interest, and wherein the graph generation component further generates the class neighborhood graph by determining distances between the classified structures based on measurements from center points of the classified structures to center points of other classified structures.

3. The system of claim 2, wherein the graph generation component comprises an image processing subcomponent that classifies the structures within the region of interest.

4. The system of claim 1, wherein the design schematic comprises a textual description of the sample, and wherein the graph generation component further generates the class neighborhood graph by determining distances between the classified structures based on an extraction of the distances from the textual description.

5. The system of claim 4, wherein the graph generation component classifies the structures based on an extraction of class descriptions within the textual description.

6. The system of claim 1, wherein the region of interest comprises a left boundary, a right boundary, a first milling stage thickness and a final thickness.

7. The system of claim 1, wherein the computer executable components further comprise, a milling neural network that classifies one or more structures in an image of a cutface of the sample, modifies the classifications based on the class neighborhood graph, and instructs a scientific instrument to mill the sample based on the modified classifications.

8. A computer-implemented method comprising:
generating, by a device operatively coupled to a processor, a class neighborhood graph for a lamella milling process, wherein the generating comprises:
classifying, by the device, structures within a region of interest of a design schematic of a sample; and
generating, by the device, a directed graph of the region of interest, wherein the directed graph comprises nodes representing the classified structures and weighted directed edges between the nodes representing distances between the classified structures.

9. The computer-implemented method of claim 8, wherein the design schematic comprises a diagram of the sample and the region of interest and further comprising determining, by the device, distances between the classified structures based on measurements from center points of the classified structures to center points of other classified structures.

10. The computer-implemented method of claim 9, further comprising classifying, by the device, the structures within the region of interest.

11. The computer-implemented method of claim 8, wherein the design schematic comprises a textual description of the sample and further comprising determining, by the device, distances between the classified structures based on an extraction of the distances from the textual description.

12. The computer-implemented method of claim 11, further comprising classifying, by the device, the structures based on an extraction of class descriptions within the textual description.

13. The computer-implemented method of claim 8, wherein the region of interest comprises a left boundary, a right boundary, a first milling stage thickness and a final thickness.

14. The computer-implemented method of claim 8, further comprising:
classifying, by the device, using a milling neural network, one or more structures in an image of a cutface of the sample;
modifying, by the device, the classifications based on the class neighborhood graph; and
instructing, by the device, a scientific instrument to mill the sample based on the modified classifications.

15. A computer program product comprising a non-transitory computer-readable memory, having program instructions embodied therewith, the program instructions executable by a processor to cause the processor to:
generate, by the processor, a class neighborhood graph for a lamella milling processes, wherein the generation causes the processor to:
classify, by the processor, structures within a region of interest of a design schematic of a sample; and
generate, by the processor, a directed graph of the region of interest, wherein the directed graph comprises nodes representing the classified structures and weighted directed edges between the nodes representing distances between the classified structures.

16. The computer program product of claim 15, wherein the design schematic comprises a diagram of the sample and the region of interest, and wherein the program instructions are further executable by the processor to cause the processor to determine distances between the classified structures based on measurements from center points of the classified structures to center points of other classified structures.

17. The computer program product of claim 16, wherein the program instructions are further executable by the processor to cause the processor to classify the structures within the region of interest.

18. The computer program product of claim 15, wherein the design schematic comprises a textual description of the sample, and wherein the program instructions are further executable by the processor to cause the processor to determine distances between the classified structures based on an extraction of the distances from the textual description.

19. The computer program product of claim 18, wherein the program instructions are further executable by the processor to cause the processor to classify the structures based on an extraction of class descriptions within the textual description.

20. The computer program product of claim 15, wherein the program instructions are further executable by the processor to cause the processor to:
classify, using a milling neural network, one or more structures in an image of a cutface of the sample;
modify the classifications based on the class neighborhood graph; and
instruct a scientific instrument to mill the sample based on the modified classifications.
